(19) United States
(12) Patent Application Publication
(10) Pub. No.: US 2023/0419420 A1
(43) Pub. Date: Dec. 28, 2023

(54) TOOL FOR CREATING AND MANAGING SOCIAL MEDIA-BASED CONTESTS WITH PRESENTATION-BALANCING COMPONENT AND STRENGTH-SCORING COMPONENT

(71) Applicant: Haa Holdings, Inc., Purcellville, VA (US)

(72) Inventors: Aaron Francis LYONS, Purcellville, VA (US); Matthew RUSSOTTI, Brooklyn, NY (US); Jason LYONS, Arlington, VA (US); Ben LYONS, Arlington, VA (US); Bryan POWELL, Austin, TX (US)

(73) Assignee: Haa Holdings, Inc., Purcellville, VA (US)

(21) Appl. No.: 18/340,406

(22) Filed: Jun. 23, 2023

Related U.S. Application Data
(60) Provisional application No. 63/354,877, filed on Jun. 23, 2022.

(51) Int. Cl. G06Q 50/00; G07C 13/00

(52) U.S. Cl. CPC G06Q 50/01; G07C 13/00

(57) ABSTRACT

Social media-based contest management systems and methods are disclosed. Participants submit and vote for short videos. The votes are tallied, and the winning videos are presented on a post leaderboard. Users creating and submitting winning videos may receive rewards such as points that may be used to purchase items in an online store. Non-fungible tokens (NFT) may be associated with the videos, and the price of an NFT may be set according to the position of the video on the post leaderboard.

### CROSS REFERENCE TO RELATED APPLICATIONS

The present application claims priority to U.S. Provisional Patent Application No. 63/354,877, filed Jun. 23, 2022, entitled “SOCIAL MEDIA-BASED CONTEST MANAGEMENT SYSTEMS AND METHODS THEREFOR,” the disclosure thereof incorporated by reference herein in its entirety.

### DESCRIPTION OF RELATED ART

The disclosed technology relates generally to social media systems, and more particularly some embodiments relate to managing contests in such systems.

### SUMMARY

Embodiments of the disclosed technologies include a platform for managing and judging social media contests where contest creators and/or submitters submit videos (or other media) and voters vote for which of the submissions (e.g., videos) the voter prefers including a presentation balancing component (e.g., to attempt to balance the number of times a submission is shown to voters) and a judging component that factors in the value of a vote based on the set of videos or other submissions that the voter has seen in connection with the contest, before voting. The contest creator may specify a set of contest parameters as detailed below. The contest creator may make a submission to the contest. Other submitters may submit submissions to the contest. The submissions may be presented to users who vote on the submissions (“voters”).

In some cases the presentation may include presenting simultaneously two (or more) submissions and the voter selects their favorite, thus registering the selected video as their favorite among the presented videos. In other cases, a voter may consecutively view a set of submissions (e.g., one at a time) and has the option to designate a submission as their current “favorite”, effectively “voting” for that video as their favorite among all submissions they have viewed in that contest to that point, with the knowledge that only one submission in a contest can have the “favorite” designation at any given point in time and that the submission designated as their favorite at the end of the “voting period” will receive their final and/or official “vote” as their “preferred submission” among all submissions they have viewed from that contest. In either case, the system stores a record of the submissions viewed by a voter. The stored record may be used by the system in connection balancing the number of times a submission is viewed during the contest and in connection with evaluating the votes. For example, if a voter is presented two videos and votes for one, the system may determine the number of times that the other submission was voted on by other voters. A vote for a submission when the other submission has received a relatively high number of votes from other voters may be more valuable than a vote where the other submission has received relatively few votes from other voters.

The disclosed technologies feature a social media-based contest tool that may be scaled across any sized network to objectively determine the preferred video of a video contest having any number of videos, even when the size of the contest is so large that a voting user can only see a subset of all videos submitted to that contest. In part, this is accomplished by using a presentation-balancing component which is configured to manage the presentation of submissions to voters in an attempt to balance the number of times a video is presented for vote during a contest. This mitigates the problems with social media based contests where some submissions are viewed many more times than others.

The presentation-balancing component that may include a feed algorithm that is configured to manage the presentation of submission within a contest to ideally attempt to manage the presentation such that the various submission are seen equally by all users voting in that contest. The algorithm uses the stored record of the times the submissions have been seen and based thereon determines which submissions should be subsequently presented.

The tool may feature a strength-scoring component that may include an algorithm that values a vote by a voter for a video in a contest based on the number of votes received by other videos in that contest that the voter has seen. The algorithm may employ scoring techniques such as strength-of-schedule scoring and similar scoring techniques.

In a contest, the votes are tallied, and the winning videos are presented on one or more post leaderboards.

The post leaderboard for a contest lists the videos in the contest in order by number of votes received for the videos. The post leaderboard may display thumbnails of the videos, creators of the videos, names of the videos, and/or hashtags associated with the videos. Non-fungible tokens (NFT) may be associated with the videos, and the price of an NFT may be set according to the position of the video on the post leaderboard. Contest creators may receive points based on how often others submit videos to contests or vote in contests the user creates. Additionally, submitters may receive points based on how many votes are received for the videos they submit, how well videos they submit perform on the post leaderboard of the contests their videos are submitted to, the number of times they vote in a contest, and/or based on how many cumulative points the user earns during a set period of time. By way of a non-limiting example, users may receive points for how many points they accumulate during a set period of time compared to the points scored by others in the community. The interval for submitting and voting for videos may be set by the contest creator as contest parameters and or as system defaults.

In some embodiments, the contest is conducted in an “array” manner, referred to herein as “consecutive judging”. In this arrangement, a voting user is presented consecutively with a subset of two or more of the videos in the contest, and votes for a favorite. In some embodiments, the contest is conducted in a “face-off” manner, referred to herein as “simultaneous judging”. In this arrangement, a voting user is presented simultaneously with two (or more) videos, and votes for the preferred one of the videos. In either arrangement, the system uses presentation balancing in an attempt to balance the number of times and the order in which the videos are presented across the voting users during a contest.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example of a social media-based contest management system according to some embodiments of the disclosed technologies.

FIG. 2 is a flowchart illustrating a simultaneous judging social media-based contest management process according to some embodiments of the disclosed technologies.

FIG. 3 depicts a user interface that may be displayed by the app for uploading a video according to some embodiments of the disclosed technologies.

FIG. 4 depicts a user interface that may be displayed by the app to enable voting users to select categorized contests according to some embodiments of the disclosed technology.

FIG. 5 depicts a user interface that may be displayed by the app for a voting user to view and vote for videos according to some embodiments of the disclosed technologies.

FIG. 6 depicts a user interface that may be displayed by the app for displaying a rendering of a post leaderboard data structure for a category according to some embodiments of the disclosed technologies.

FIG. 7 is a flowchart illustrating a consecutive judging social media-based contest management process 700 according to some embodiments of the disclosed technologies.

FIGS. 8A-D illustrate example user interfaces for submitting a video according to some embodiments of the disclosed technology.

FIGS. 9A-C illustrate example user interfaces for viewing videos and casting votes for videos.

FIG. 10 depicts a user interface that may be displayed by the app for displaying a rendering of a user leaderboard data structure according to some embodiments of the disclosed technologies.

FIG. 11 is an example computing component that may be used to implement various features of embodiments described in the present disclosure.

FIG. 12 illustrates a user interface that may be provided by the tool to select parameters for a contest according to some embodiments of the disclosed technology.

The figures are not exhaustive and do not limit the present disclosure to the precise form disclosed.

### DETAILED DESCRIPTION

Social media has become ubiquitous. This technology allows users to create virtual communities called social networks, and to create and share media through those social networks. Many platforms have been developed for the creation and sharing of all types of media, including text, music, images, and video.

Gamification is the application of game mechanics to realms not traditionally considered games. These game mechanics may include contests, the awarding of points, leaderboards showing the results of a competition, and other game elements.

Embodiments of the disclosed technologies gamify social media to provide a social media-based contest management system. While in various embodiments the media is described as videos, these embodiments are equally applicable to other media. These media may include photos, written phrases, virtual reality (VR) media, augmented reality (AR) media, artificial intelligence (AI) generated files, musical compositions, or any other type of content existing now or to be invented in the future. For simplicity, the description will refer to submissions as being videos for example, but it is to be understood that the examples relating to videos can apply to submissions of other media.

Users who create contests are referred to herein as “creators” or “contest creators”. The tool may allow a contest creator to create a social media contest with or without submitting a video for the contest. The contest creator may select a set of contest parameters for the contest. For example, the contest parameters may include one or more of a contest name, category, contest presentation options (e.g., simultaneous or consecutive display of submissions), voter eligibility criteria (e.g., public, private designated list and/or other criteria), submission time parameters, voting time parameters and/or other contest parameters. The contest parameters are stored and used by the system to manage the contest, including submissions, presentation of submissions, voting and determination of a winning submission.

The contest creator may select a name for the contest and/or category, which enables the tool to organize videos in sets denoted by contest names or subject matter. For example, a contest creator may associate the contest with a category via a hashtag or other category designator. This allows users to filter and search videos and/or contests by category. For example, the categories may be tonal, thematic, and/or interest-based or other types of categories.

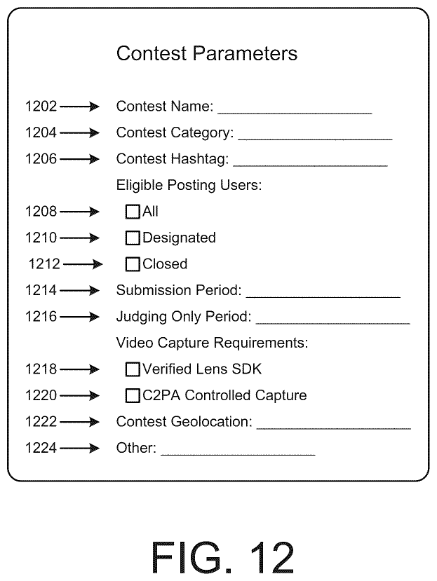

The contest parameters may be presented to the contest creator via a user interface as shown for example in FIG. 12. The contest parameters may be stored by the system and used in connection with determining the display format for the contest (simultaneous display of a predetermined number of videos or consecutive display).

FIG. 12 illustrates a user interface that maybe provided by the tool to select parameters for a contest according to some embodiments of the disclosed technology. Referring to FIG. 12, the parameters may include contest name 1202, contest category 1204, and contest hashtag 1206. The tool may allow a user to specify the pool of eligible posting users for the contest. For example, the pool may include all posting users 1208, a designated subset of the posting users 1210, or may be closed 1212 so only the user creating the contest may post videos to the contest. For example, the tool may allow a representative of a business or other entity (e.g. a resort chain) to create a contest by posting videos (e.g., of several resorts and to name the contest “Choose Your Getaway”). The parameters may include the duration 1214 of a submissions period during which submitters may submit videos and voting users may vote for the submitted videos, and the duration 1216 of a judging only period during which submissions are closed but voting users may continue to vote. The parameters may include required capture characteristics for the videos. For example, the required capture characteristics to ensure integrity of the submission (e.g., video) may include verified lens SDK 1218 and/or C2PA controlled capture 1220. The parameters may include a required geolocation 1222. Customized parameters may be established by selecting an “Other” display element 1224.

Once a contest has been created, eligible users, referred to as “submitters” or “posting users”, may submit videos to the contest. The videos may be judged by users, referred to herein as “voting users” or “voters”, through a voting or ranking process. A voter may vote in a contest. A submitter may submit and vote in a given contest. A contest creator can create, submit and vote in a given contest. But in some examples, a submitter and/or contest creator may be prohibited from voting on videos submitted by that submitter.

The voting process may be structured in several ways. In one embodiment, referred to herein as “simultaneous judging”, the voting process presents the videos in pairs, allowing the voting user to choose one of the videos over another. In one embodiment, referred to herein as “consecutive judging”, the voting process consecutively presents two or more videos from a set of videos to a voting user, allowing the voting user to vote for one of the presented videos. Other embodiments are contemplated. Features of different embodiments may be combined as desired. For example, features of the voting and/or scoring processes described for the simultaneous judging process may be incorporated in embodiments of the consecutive judging process, and vice-versa.

In the voting process, voting users may select one of the categories or a specific contest, for example by selecting a category designator (e.g., a title, hashtag or other designator). Responsive to this selection, the system may select a set of videos corresponding to the selected category or contest.

For a voting user, the system may select a subset of the selected set of videos for that voting user to vote on or rank. The subset may include two or more videos. The system may provide the selected subsets to client devices for display to the voting users. The system may select different subsets for different voting users. In some embodiments, the system may manage the overall selection of videos in a contest such that the overall number of times a video is selected for inclusion in a subset is equitable with respect to the number of times other videos in the set of videos are selected. In some embodiments, the system may manage the selection of videos in a contest such that the overall number of times the videos are selected for inclusion in a subset is the same.

The system may provide a user interface to client device. The user interface may include a presentation portion for presenting the videos in the respective subset to the voting user. The system may present the videos in any manner. For example, two or more of the videos may be presented simultaneously or in sequence. The user interface may include an interactive element operable by the voting user to generate an input representing a vote. In the voting process, the voting user may vote for at least one of the selected videos in the set with respect to one or more other videos in the set. For example, the presentation portion may display two videos simultaneously, and the interactive element may allow the voting user to select one of the videos via the user input. The user interface may then simultaneously present a third video along with the winning video. In another example, the presentation portion presents the videos in the set consecutively in a sequence, and a vote represents a preference for a currently-playing video with respect to one or more videos played immediately before the currently-playing video. In an example of the consecutive judging process, the system may allow the voting user to vote for a video in the set without the comparison process of the simultaneous judging process. In any event, this process may continue until the voting user has compared the videos in the subset to at least one other video in the subset.

The system may receive electronic messages representing the votes from the client devices of the voting users. The system may tally the votes, and may generate a post leaderboard data structure representing a list of the videos ordered according to the received votes. In some embodiments, the votes may be tallied by calculating a score for a video that is a function of votes for the video and/or votes for other videos in the set, and ordering the list of the videos according to the scores.

In some embodiments, the system may generate post leaderboard data structures by category. In some embodiments, the system may generate a single overall post leaderboard data structure for all categories. The system may provide, for display by the client devices of the voting users and/or posting users, the post leaderboard data structure and an electronic user interface portion comprising a second presentation portion for displaying a rendering of the post leaderboard data structure.

In some embodiments of the simultaneous judging process, the system may provide a video subset to a voting user a second time to obtain comparisons between videos that were not previously compared by the voting user. For example, when the videos were presented in a first sequence during a first simultaneous judging, the system may present the videos in a different sequence in a second simultaneous judging. The resulting votes may then be tallied and incorporated into the post leaderboard data structure.

In some embodiments, the system may rank the voting users according to consistency of their preferences in a process referred to herein as a “taste test” to obtain a “taste score” for the voting user. In these embodiments in the simultaneous judging process, the system may provide a video set to a voting user a second time for the voting user to compare the same videos previously compared. For example, when the videos were presented in a first sequence during a first simultaneous judging, the system may present the videos in the same sequence in a second simultaneous judging. In some embodiments, the videos may be presented in a different order to thwart the use of bots and similar techniques. The system may process the votes from the two simultaneous judgings to obtain a taste score. The system may then generate a taste leaderboard data structure that represents an ordered list of the voting users according to the scores.

A taste score may represent a degrees of correspondence between the first and second votes of the voting user, a degree of correspondence between the preferences of the voting user and an aggregate of the preferences of the voting users, and/or a degree of correspondence between the preferences of the voting user and an aggregate of the preferences of other voting users who share one or more characteristics with the voting user.

The system may provide rewards to the users. The posting users may be rewarded according to the positions of videos they submitted on the post leaderboard data structure. The voting users may be rewarded according to their positions on the taste leaderboard data structure. The voting users may be rewarded according to how they appear on a user leaderboard of all users according to points earned during a specified period of time.

In some embodiments, posting users may post videos they did not create. In such embodiments, the creator of the posted video may be rewarded. In the event such creators are not members of the platform, the points the creators earn may be held and granted to them when they join the platform. In some embodiments, when uploading content created by others, a posting users must give credit to the original creator to qualify for points or bonuses awarded to that post or according to the post's cumulative performance in numerous contests over time.

In some embodiments, non-fungible tokens (NFT) may be associated with the videos. In such embodiments, the price of an NFT may be set according to the position of the video on the post leaderboard data structure.

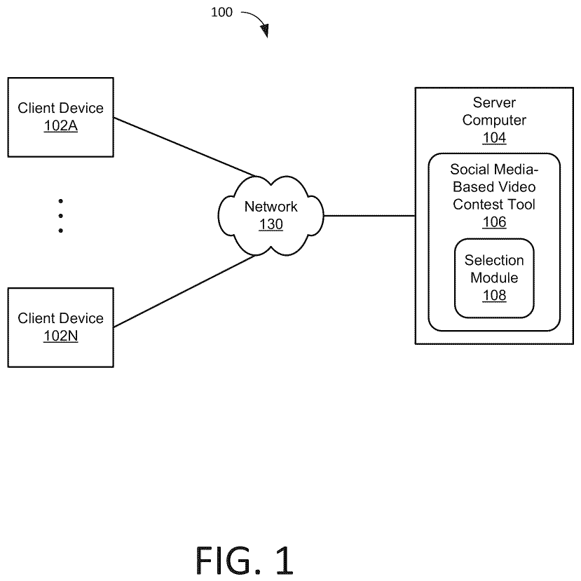

FIG. 1 illustrates an example of a social media-based contest management system 100 according to some embodiments of the disclosed technologies. The system 100 may include multiple client devices 102A-N and one or more server computers 104. The client devices 102 and server computer(s) 104 may communicate over one or more networks 130. A social media-based contest tool 106 may execute on server computer 104. The social media-based contest tool 106 may include a selection module 108. Users may operate the client devices 102 to interact with the social media-based contest tool 106.

In this disclosure, the client devices 102 are described as smartphones. However, it will be appreciated that any suitable electronic device may be used. The client devices 102 may execute code to perform the described functions. In this disclosure, the code is described as a dedicated app. However, it will be appreciated that other code may be used. For example, the code may take the form of a browser.

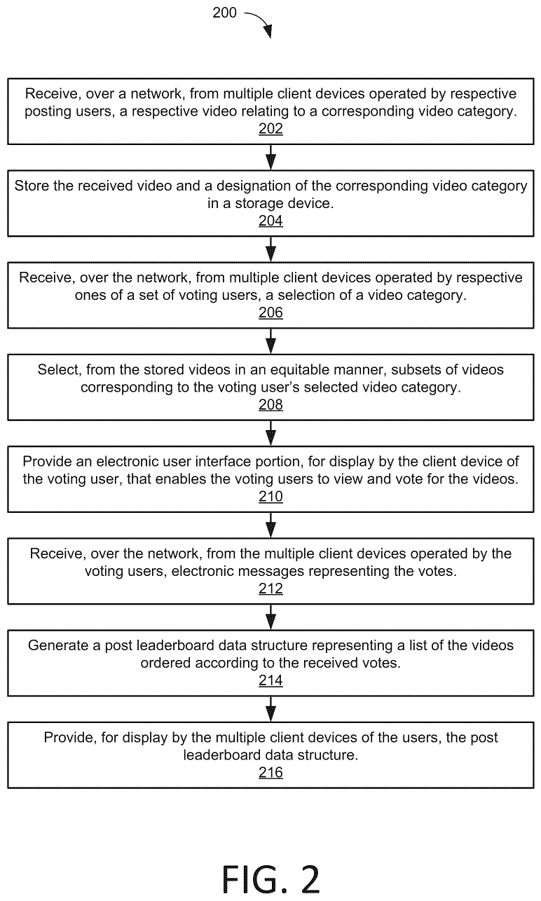

FIG. 2 is a flowchart illustrating a simultaneous judging social media-based contest management process 200 according to some embodiments of the disclosed technologies. The elements of the process 200 are presented in one arrangement. However, it should be understood that one or more elements of the process may be performed in a different order, in parallel, omitted entirely, and the like. Furthermore, the process 200 may include other elements in addition to those presented. For example, the process 200 may include error-handling functions if exceptions occur, and the like. The process 200 may be implemented, for example, by the social media-based contest tool 106 of FIG. 1.

Referring to FIG. 2, the process 200 may include receiving, over a network, from multiple client devices operated by respective posting users, a respective video relating to a corresponding video category, at 202. For example, a posting user may operate an app executing on a smartphone to select a video category and upload a video to the social media-based contest tool 106. The process 200 may include storing the received video and a designation of the corresponding video category in a storage device, at 204.

In some embodiments, community curators may parse the posts to determine when and which posts will be released in a simultaneous judging. This process allows great variation within the types of submission hashtags because of the various ways curators can choose what is in a simultaneous judging. Curator-managed simultaneous judgings may have a finite number of posts. In some embodiments, curators may create a hashtag and post some or all of the videos for that hashtag.

In some embodiments, a hashtag might require users to use a particular software package to upload a video. For instance, the system might provide the API of a camera app which verifies the chain of custody of digital content, tracking when the content was created and whether it was modified.

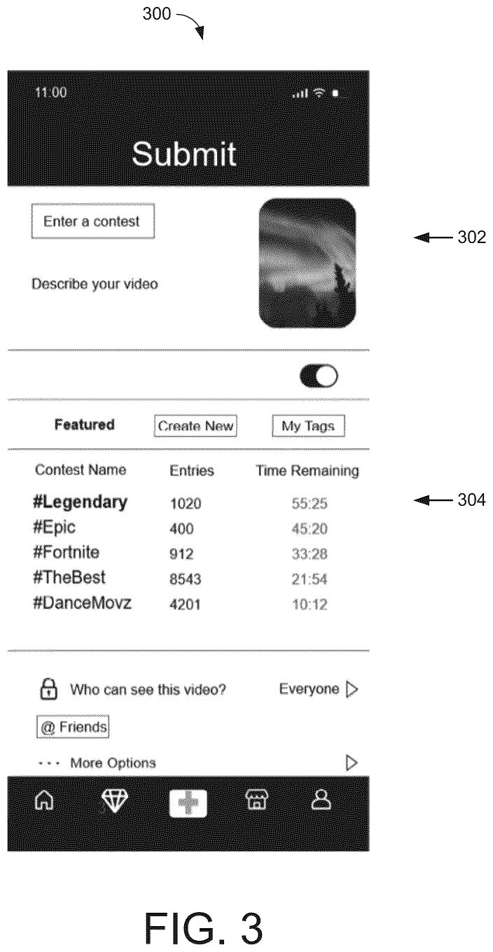

FIG. 3 depicts a user interface 300 that may be displayed by the app for uploading a video according to some embodiments of the disclosed technologies. The user interface 300 may include a panel 302 having interactive elements operable by the posting user to select a video to upload. The user interface 300 may also include a panel 304 having interactive elements operable by the posting user to select a contest in which to enter the video. In this example, a contest corresponds to a category labeled with a hashtag.

Referring again to FIG. 2, the process 200 may include receiving, over the network, from multiple client devices operated by respective ones of a set of voting users, a selection of a video category, at 206. Video categories may be represented by different hashtags. Voting users may operate interactive elements in a user interface provided by the system to make this selection.

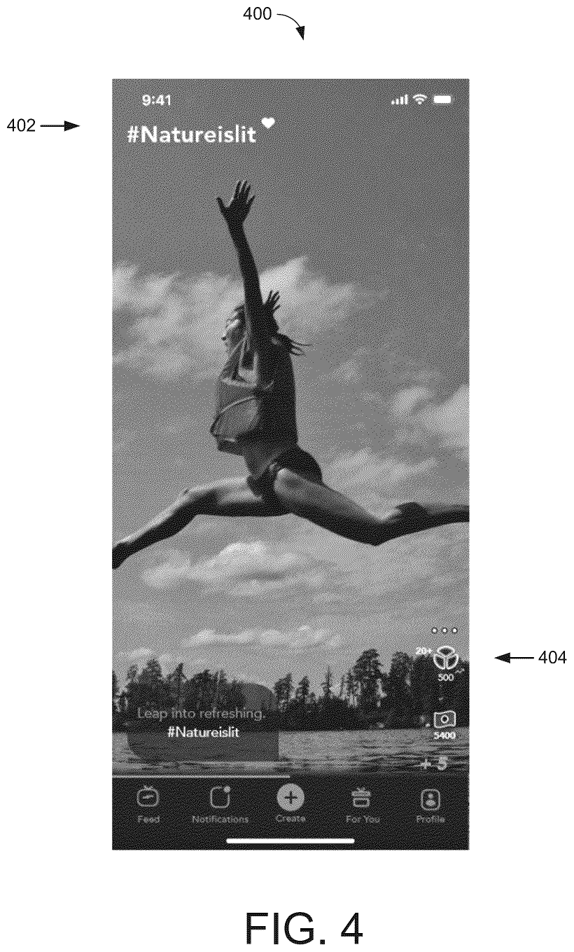

FIG. 4 depicts a user interface 400 that may be displayed by the app to enable voting users to select contests according to some embodiments of the disclosed technology. In the example of FIG. 4, voting users may begin by viewing videos in full screen mode. In some embodiments, a voting user may use scrolling to select different contests and videos. For example, a voting user may select different videos within the same contest by swiping horizontally, and may select different contests by swiping vertically. When the voting user is happy with the category or contest, the vote process may enter face-off voting mode by selecting an interactive element. Referring to FIG. 4, the contest #Natureislit is shown at 402, and an interactive element is shown at 404.

As noted above, the social media-based contest tool 106 may include a selection module 108. The process 200 may include selecting, by the selection module 108, from the stored videos in an equitable manner, subsets of videos corresponding to the voting user's selected video category, at 208. For example, the process 200 may utilize an algorithm that ensures all videos in a contest are selected and put into subsets an equal number of times. The subset of videos for a given voting user may include a video subset referred to herein as a “simultaneous judging set” comprising at least two videos. The selection module 108 may select different subsets for different voting users. The selection module 108 may manage the overall selection of selected videos such that the overall number of times a video is selected is equitable with respect to the number of times other videos in the set of videos are selected.

The process 200 may include providing an electronic user interface portion, for display by the client device of the voting user, that enables the voting users to view and vote for the videos, at 210. The electronic user interface portion may include a presentation portion for presenting the videos in the subset selected by the selection module 108 for that voting user, and an interactive element operable by the user to generate an input representing a vote for at least one of the selected videos in the sub set with respect to one or more other videos in the subset.

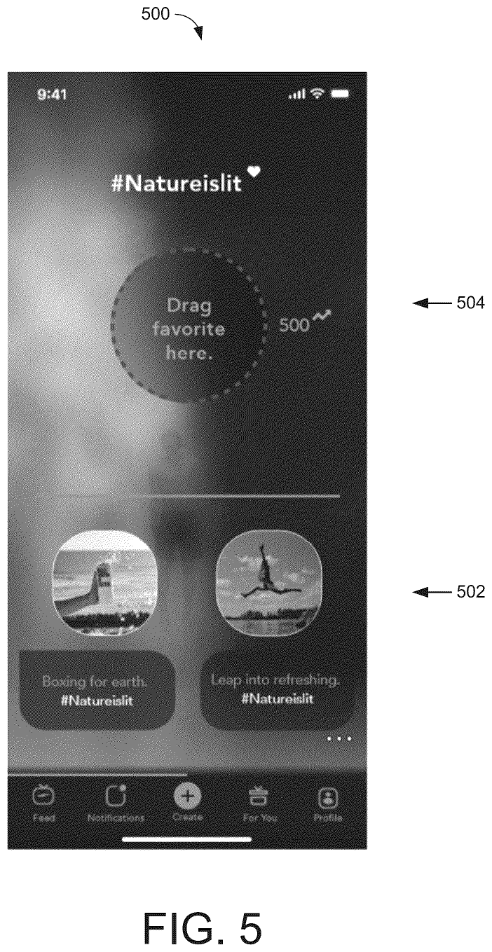

FIG. 5 depicts a user interface 500 that may be displayed by the app for a voting user to view and vote for videos according to some embodiments of the disclosed technologies. The user interface 500 includes a presentation portion 502 for presenting two videos in a subset as part of a simultaneous judging for the category hashtag #natureislit. Referring to FIG. 5, the two videos are entitled “Boxing for earth” and “Leap into refreshing”. In this example, the voting user may vote by dragging a preferred one of the two videos into a winner's circle, shown at 504. In other embodiments, the voting user may enter a vote by activating a selection icon for one of the videos. In various embodiments, the system may or may not identify the posting users who posted the videos to the voting users during the simultaneous judging.

The voting user may receive points for completing a simultaneous judging. The points may be redeemed for rewards, coupons, food, and similar rewards. After completing a simultaneous judging, the voting user may elect to enter a bonus round to complete comparisons not presented, that is, to vote on comparisons of the videos. On completing the bonus round, the voting user may be awarded additional points. In either the original simultaneous judging or the bonus round, the videos may be presented two at a time, three at a time, or more. Higher-order comparisons have the advantage of requiring fewer comparisons and votes.

Referring again to FIG. 2, the process 200 may include receiving, over the network, from the multiple client devices operated by the voting users, electronic messages representing the votes, at 212, and generating a post leaderboard data structure representing a list of the videos ordered according to the received votes, at 214. The process 200 may include providing, for display by the multiple client devices of the users, including contest creators, voting users and/or posting users, the post leaderboard data structure, at 216. That is, the system may provide, over the network, for display by the multiple client devices of the users, the post leaderboard data structure and a second electronic user interface portion comprising a second presentation portion for displaying a rendering of the post leaderboard data structure. In some embodiments, the system may require a minimum predetermined number of simultaneous judgings and/or a predetermined voting interval before tallying the votes.

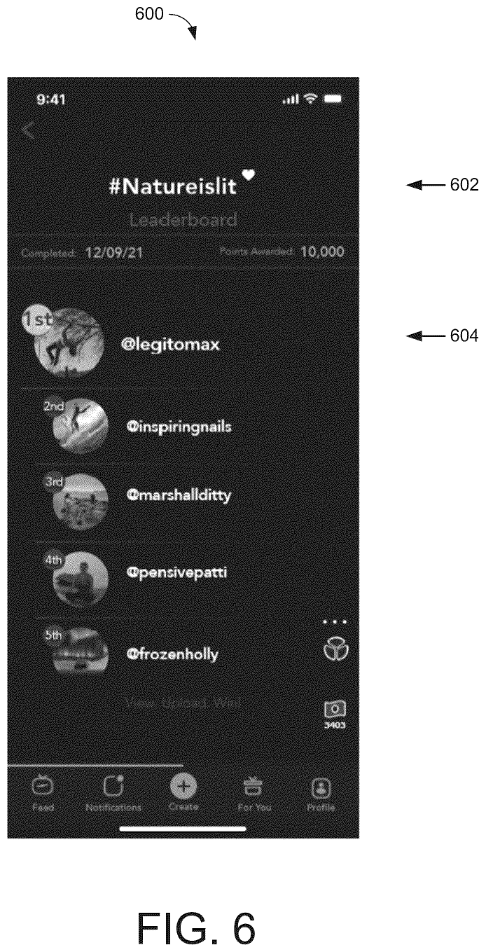

FIG. 6 depicts a user interface 600 that may be displayed by the app for displaying a rendering of a post leaderboard data structure for a category according to some embodiments of the disclosed technologies. The user interface 600 may include a panel 602 that lists the hashtag for the post leaderboard, here “Natureislit”. The user interface 600 may include a panel 604 for listing the top videos and their creators.

Simultaneous judgings for a selected set of videos may continue until a period of time has elapsed or a selected minimum number of simultaneous judgings have been completed by a selected minimum number of unique users. In some embodiments, at regular intervals (daily, weekly, monthly, etc.), the post leaderboard and taste leaderboard of completed simultaneous judgings may be made public, and top performers may be rewarded with a notification to the entire user community.

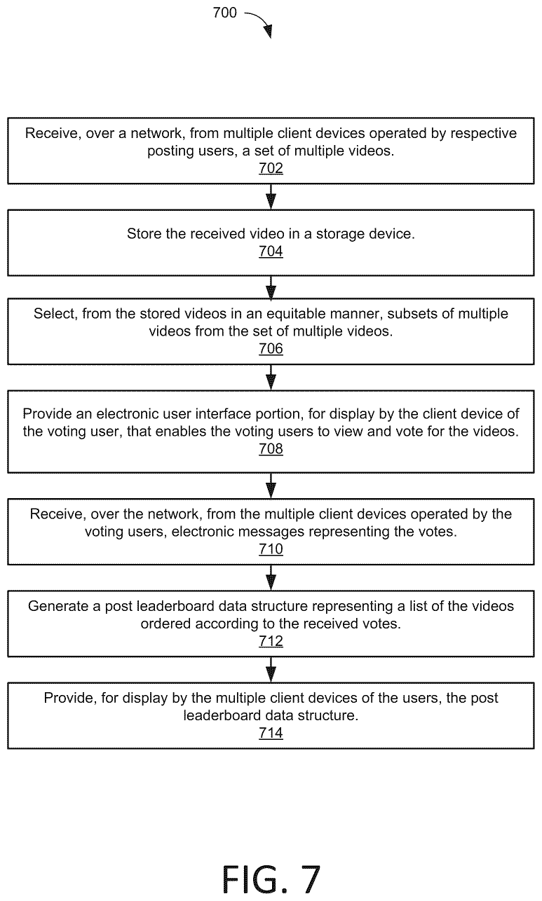

FIG. 7 is a flowchart illustrating a consecutive judging social media-based contest management process 700 according to some embodiments of the disclosed technologies. The elements of the process 700 are presented in one arrangement. However, it should be understood that one or more elements of the process may be performed in a different order, in parallel, omitted entirely, and the like. Furthermore, the process 700 may include other elements in addition to those presented. For example, the process 700 may include error-handling functions if exceptions occur, and the like. The process 700 may be implemented, for example, by the social media-based contest tool 106 of FIG. 1.

Referring to FIG. 7, the process 700 may include receiving, over a network, from multiple client devices operated by posting users, a set of multiple videos, at 702. For example, a posting user may operate an app executing on a smartphone to select a video category and upload a video to the social media-based contest tool 106. The process 700 may include storing the received videos in a storage device, at 704.

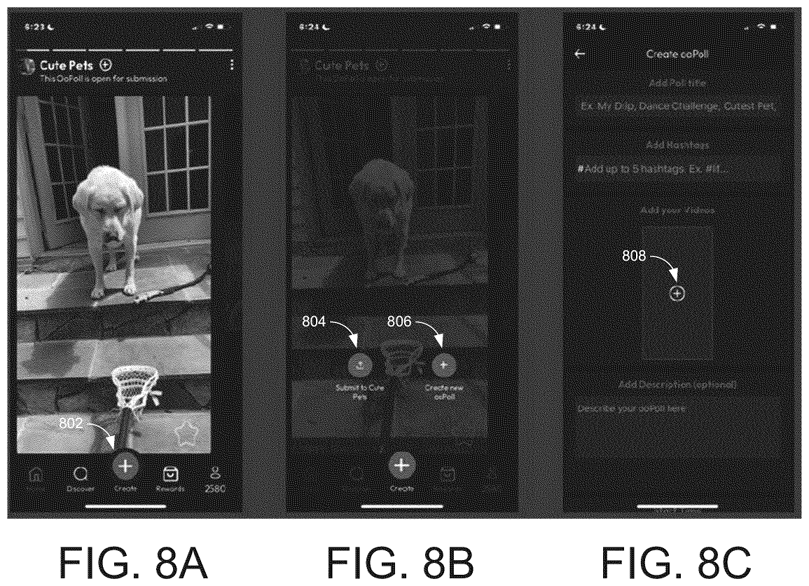

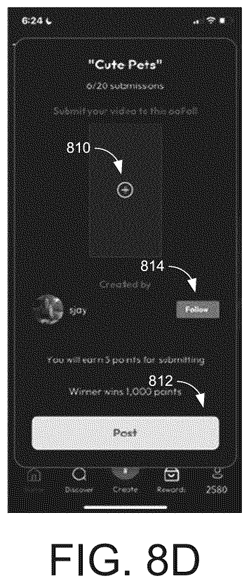

A posting user may submit a video to an existing consecutive judging, or may create a new consecutive judging. FIGS. 8A-D illustrate example user interfaces for submitting a video according to some embodiments of the disclosed technology. The user interface of FIG. 8A includes a presentation portion showing a video in an existing consecutive judging entitled “Cute Pets”, and multiple interactive elements including a “Create” button 802 operable by the voting user to submit a video.

The user interface of FIG. 8B may be presented responsive to operation of the “Create” button 802. The user interface of FIG. 8B includes a “Submit to Cute Pets” button 804 operable to submit a video to the existing “Cute Pets” consecutive judging and a “Create New consecutive judging” button 806 operable to create a new consecutive judging. The user interface of FIG. 8C may be presented responsive to operation of the “Create New consecutive judging” button 806. The user interface of FIG. 8C includes a “+” button 808 that allows the user to add a video to the new consecutive judging and portions that allow the user to enter a consecutive judging title, one or more hashtags for the consecutive judging, and a description of the video.

The user interface of FIG. 8D may be presented responsive to operation of the “Submit to Cute Pets” button 804 of the user interface of FIG. 8B. The user interface of FIG. 8D includes a button 810 that allows the user to select a video, a button 812 that allows the user to post the video to the “Submit to Cute Pets” consecutive judging, and a “Follow” button 814 that allows the user to follow the creator of the consecutive judging on social media.

As noted above, the social media-based contest tool 106 may include a selection module 108. Referring again to FIG. 7, the process 700 may include selecting, from the stored videos in an equitable manner, via the selection module 108, subsets of multiple videos from the set of multiple videos, at 706. For example, the process 700 may utilize an algorithm that ensures all videos in a contest are selected and put into subsets an equal number of times. The selection module 108 may select different subsets for different voting users. The selection module 108 may manage the overall selection of the subsets of multiple videos such that the overall number of times a given video in the set of multiple videos is selected is equitable with respect to the number of times other videos in the set of multiple videos are selected. For example, the platform may not send any videos in a consecutive judging to a second user until all of those videos have been viewed by a first user.

Referring again to FIG. 7, the process 700 may include providing an electronic user interface portion, for display by the client devices of the voting users, that enables the voting users to view and vote for the videos, at 708. The electronic user interface portion may include a first electronic user interface portion comprising a first presentation portion for presenting the videos in one of the subsets selected by the selection module 108 for the given voting user, and a first interactive element operable by the given voting user to generate an input representing a vote for at least one of the videos in the one of the subsets.

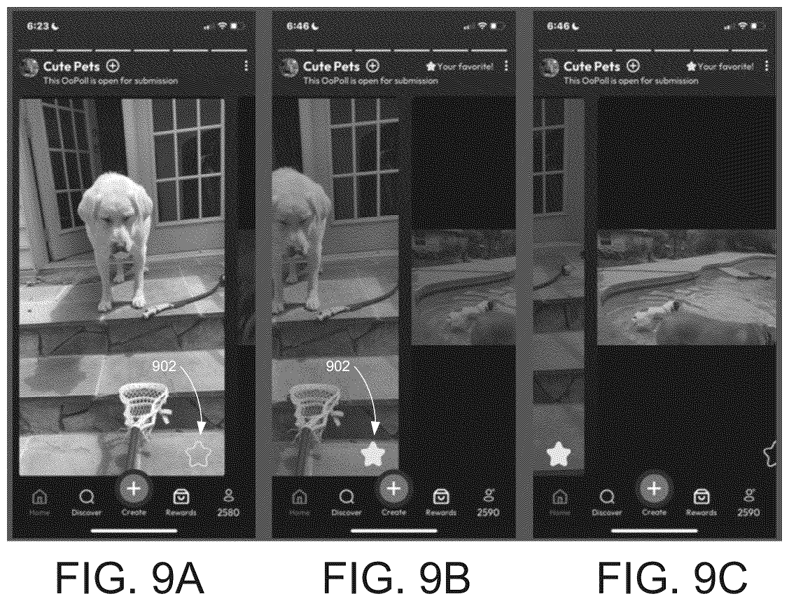

FIGS. 9A-C illustrate example user interfaces for viewing videos and casting votes for videos. The user interface of FIG. 9A includes a presentation portion showing a video in a consecutive judging entitled “Cute Pets”, and multiple interactive elements including a star button 902 operable by the voting user to vote for the video. In the user interfaces of FIGS. 9B and 9C, the user has voted for the video, as indicated by a change in the appearance of the star button 902, and is swiping left to view another video.

In some embodiments, the platform may divide the consecutive judging process into two periods: a submission period followed by a judging only period. During the submission period, posting users may submit videos and voting users may submit votes for the videos. During the judging only period, no users may submit videos but voting users may continue to submit votes for the videos. The judging only period allows time for the selection module 108 to ensure videos submitted near the end of the submission period are viewed the same or similar number of times as videos submitted earlier. In some embodiments, the length of the judging only period may be chosen by the creator of the consecutive judging. In some embodiments, the length of the judging only period may be set by the platform, either to a default value or by an algorithm that assures all videos are viewed the same or similar number of times.

Referring again to FIG. 7, the process 700 may include receiving, over the network, from the multiple client devices operated by the voting users, electronic messages representing the votes, at 710, and generating a post leaderboard data structure representing a list of the videos ordered according to the received votes, at 712.

When the judging period ends, the consecutive judging ends and the videos are scored and ranked. The process 700 may include providing, for display by the multiple client devices of the users, including creator, voting users and/or posting users, the post leaderboard data structure, at 714. That is, the system may provide, over the network, for display by the multiple client devices of the users, the post leaderboard data structure and a second electronic user interface portion comprising a second presentation portion for displaying a rendering of the post leaderboard data structure.

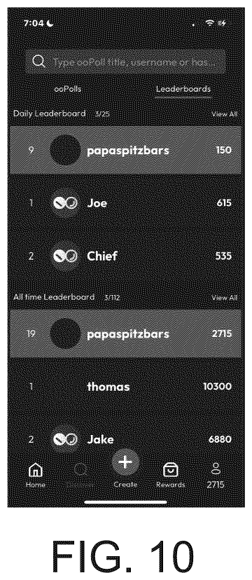

The votes in one or more contests may be tallied on a per-user basis to rank users and generate a user leaderboard data structure that reflects that ranking. FIG. 10 depicts a user interface that may be displayed by the app for displaying a rendering of a user leaderboard data structure according to some embodiments of the disclosed technologies.

The scoring may include calculating raw scores for the videos in the consecutive judging. The raw score for a given video may be calculated based on (i) the number of times the given video is seen by the voting users and (ii) the number of votes cast for the given video. For example, the raw score for a given video may be calculated by dividing the number of votes cast for the given video by the number of times the given video is seen by the voting users.

The scoring may include calculating strength of schedule (SOS) scores for the videos in the set of multiple videos based on wins for the videos. A video maybe accorded a win when the video receives a vote from a voting user. The SOS score for a given video may be calculated based on (i) the raw scores of other videos in subsets where the given video is accorded a win and (ii) the number of wins the given video is accorded over all other videos in the set of multiple videos. For example, the SOS score for a given video may be calculated by multiplying (i) the raw scores of other videos in subsets where the given video is accorded a win by (ii) the number of wins the given video is accorded over all other videos in the set of multiple videos.

The scoring may include calculating final scores for the videos in the set of multiple videos. The final score for a given video may be calculated based on (i) the raw score for the given video and (ii) the SOS score for the given video. For example, the final score for a given video may be calculated by adding (i) the raw score for the given video to (ii) the SOS score for the given video. The system may declare the video with the highest final score as the winner, and may order the list of the videos in the post leaderboard data structure according to the final scores.

Users may receive points when completing simultaneous judgings, posting videos to hashtags, creating hashtags, their content is ranked highly by others, they share hashtags with other users, and based on rankings in the post or taste leaderboards. Points may be used in an app store to unlock goods, discounts, services, or access to events on the app, on other apps, or in the real world. Examples of rewards users may purchase outright or purchase a ‘chance to win’ may include digital experiences, cash, access to live events, membership in a brand or fan club, digital discounts on particular products, exclusive products, shares of NFTs representing the videos, future shares of social capital and points another user's content earns on the platform, and the ability to unlock other features on the app.

In order to create a live, fluid, opportunistic, and exciting rewards environment, the app store may not be open to all users at all times. Users may get alerts when their membership in certain groups on the app or overall performance earns access to the app store. The store experience may be further enhanced by changing the store's reward offerings when time the store opens. Like brick and mortar outlet malls, discount stores, or online marketplaces, the dynamic nature of offerings makes the store exploratory, speculative, and potentially rewarding when it is visited. The store does not have to be open to redeem previously attained rewards, provided that particular reward has not expired.

Voting users may be provided insights about their personal preferences including how their answers compare to others, suggestions of friends who have similar tastes, unique opportunities to be paid by brands to provide more insights, and similar insights.

Businesses and individuals who provide rewards in the store may receive product and marketing insights based on hashtags, categories, or contests they create or that are relevant to their business. These insights are more actionable than raw data about likes, views, and subs. In addition, users know where data from particular simultaneous judgings and consecutive judgings is being sent, making data transactions transparent.

The system may provide a new collaborative genre of social media that is sometimes required by hashtags, and that is referred to here as “Stitches”. Stiches are montages made by content from numerous users who have varying knowledge of the users or the context of the other content in the montage. Creating a “random stitch” may require a user to post a video (sometimes following a script or prompt) and then wait for the platform to combine that content with content selected randomly from users who submitted content to the same stitch. In “Telephone stitches” a user may make their video, not in a complete vacuum, but by referring to the video that will precede their video in the montage. Within stitches, users may choose whether their content may be stitched with anyone on the platform, or only with a subset of users they identify. Stitches may be of any length, and may involve any number of users. All stitches result in numerous stakeholders sharing ownership and management of the resulting content (montage). Consequently, numerous people may enter Stitcher content into future hashtags, and all users who contributed to the stitch may receive points for how the content performs whether they posted it into that hashtag or not.

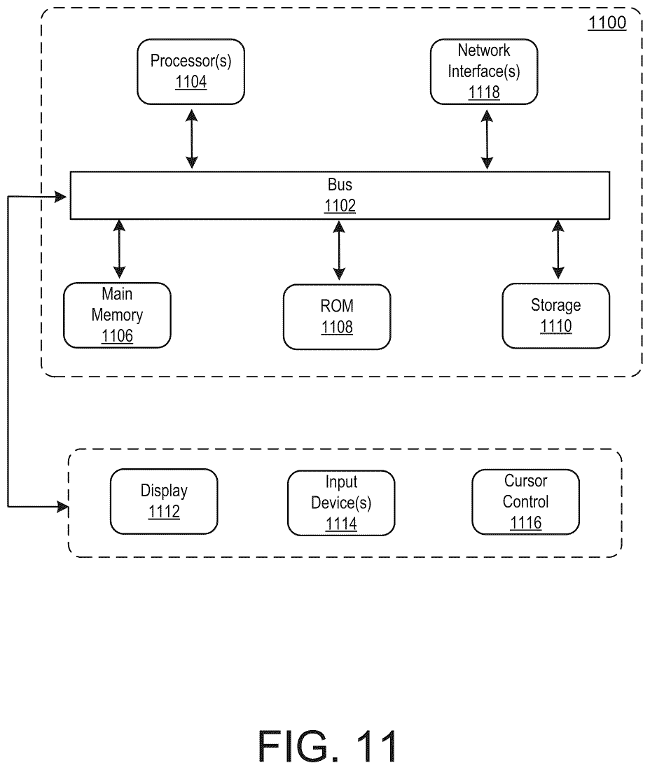

FIG. 11 depicts a block diagram of an example computer system 1100 in which embodiments described herein may be implemented. The computer system 1100 includes a bus 1102 or other communication mechanism for communicating information, one or more hardware processors 1104 coupled with bus 1102 for processing information. Hardware processor(s) 1104 may be, for example, one or more general purpose microprocessors.

The computer system 1100 also includes a main memory 1106, such as a random access memory (RAM), cache and/or other dynamic storage devices, coupled to bus 1102 for storing information and instructions to be executed by processor 1104. Main memory 1106 also may be used for storing temporary variables or other intermediate information during execution of instructions to be executed by processor 1104. Such instructions, when stored in storage media accessible to processor 1104, render computer system 1100 into a special-purpose machine that is customized to perform the operations specified in the instructions.

The computer system 1100 further includes a read only memory (ROM) 1108 or other static storage device coupled to bus 1102 for storing static information and instructions for processor 1104. A storage device 1110, such as a magnetic disk, optical disk, or USB thumb drive (Flash drive), etc., is provided and coupled to bus 1102 for storing information and instructions.

The computer system 1100 may be coupled via bus 1102 to a display 1112, such as a liquid crystal display (LCD) (or touch screen), for displaying information to a computer user. An input device 1114, including alphanumeric and other keys, is coupled to bus 1102 for communicating information and command selections to processor 1104. Another type of user input device is cursor control 1116, such as a mouse, a trackball, or cursor direction keys for communicating direction information and command selections to processor 1104 and for controlling cursor movement on display 1112. In some embodiments, the same direction information and command selections as cursor control may be implemented via receiving touches on a touch screen without a cursor.

The computing system 1100 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1100 may implement the techniques described herein using customized hard-wired logic, one or more ASICs or FPGAs, firmware and/or program logic which in combination with the computer system causes or programs computer system 1100 to be a special-purpose machine. According to one embodiment, the techniques herein are performed by computer system 1100 in response to processor(s) 1104 executing one or more sequences of one or more instructions contained in main memory 1106. Such instructions may be read into main memory 1106 from another storage medium, such as storage device 1110. Execution of the sequences of instructions contained in main memory 1106 causes processor(s) 1104 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1110. Volatile media includes dynamic memory, such as main memory 1106. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1102. Transmission media can also take the form of acoustic or light waves, such as those generated during radio-wave and infra-red data communications.

The computer system 1100 also includes a communication interface 1118 coupled to bus 1102. Network interface 1118 provides a two-way data communication coupling to one or more network links that are connected to one or more local networks. For example, communication interface 1118 may be an integrated services digital network (ISDN) card, cable modem, satellite modem, or a modem to provide a data communication connection to a corresponding type of telephone line. As another example, network interface 1118 may be a local area network (LAN) card to provide a data communication connection to a compatible LAN (or a WAN component to communicate with a WAN). Wireless links may also be implemented. In any such implementation, network interface 1118 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 1118, which carry the digital data to and from computer system 1100, are example forms of transmission media.

The computer system 1100 can send messages and receive data, including program code, through the network(s), network link and communication interface 1118. In the Internet example, a server might transmit a requested code for an application program through the Internet, the ISP, the local network and the communication interface 1118.

The received code may be executed by processor 1104 as it is received, and/or stored in storage device 1110, or other non-volatile storage for later execution.

The processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, or a combination of hardware and software. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1100.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A social media-based video contest management system for managing the equitable selection and display of videos to be voted on by users, the system comprising:
a hardware processor; and
a non-transitory machine-readable storage medium encoded with instructions executable by the hardware processor to perform operations comprising:
receiving, over a network, from multiple client devices of posting users, a set of multiple videos;
storing the received videos in a storage device;
for voting users:
selecting, from the stored videos, via a selection module, one or more subsets of multiple videos from the set of multiple videos, wherein the selection module is configured to manage the overall selection of the subsets of multiple videos such that the overall number of times a given video in the set of multiple is selected is equitable with respect to the number of times other videos in the set of multiple videos are selected; and
providing, over the network, for display by a client device of a given voting user, a first electronic user interface portion comprising a first presentation portion for presenting the videos in one of the subsets selected by the selection module for the given voting user, and a first interactive element operable by the given voting user to generate an input representing a vote for at least one of the videos in the one of the subsets;
receiving, over the network, from the multiple client devices of the voting users, electronic messages representing the votes;
generating a post leaderboard data structure representing a list of the videos ordered according to the received votes; and
providing, over the network, for display by the multiple client devices of the voting users and/or posting users, the post leaderboard data structure and a second electronic user interface portion comprising a second presentation portion for displaying a rendering of the post leaderboard data structure.

2. The social media-based video contest management system of claim 1, the operations further comprising:
establishing a submission period during which posting users may submit videos for inclusion in the set of multiple videos and the voting users may submit votes for the videos; and
establishing a judging only period during which no users may submit videos for inclusion in the set of multiple videos and the voting users may submit votes for the videos.

3. The social media-based video contest management system of claim 1, the operations further comprising:
calculating raw scores for the videos in the set of multiple videos, wherein the raw score for a given video is calculated based on (i) a number of times the given video is seen by the voting users and (ii) a number of votes cast for the given video.

4. The social media-based video contest management system of claim 3, the operations further comprising:
calculating strength of schedule (SOS) scores for the videos in the set of multiple videos based on wins for the videos, wherein a video is accorded a win when the video receives a vote from a voting user over the other videos in the subset over the other videos in the subset, and wherein the SOS score for a given video is calculated based on (i) the raw scores of other videos in the subsets where the given video is accorded a win, (ii) the number of wins the given video is accorded over all other videos in the set of multiple videos, and (iii) a total number of wins accorded the given video.

5. The social media-based video contest management system of claim 1, the operations further comprising:
calculating final scores for the videos in the set of multiple videos, wherein the final score for a given video is calculated based on (i) the raw score for the given video and (ii) the SOS score for the given video; and
ordering the list of the videos in the post leaderboard data structure according to the final scores.

6. The social media-based video contest management system of claim 1, wherein selecting, from the stored videos, via a selection module, one or more subsets of multiple videos from the set of multiple videos comprises:
selecting, from the stored videos, via the selection module, a simultaneous judging set comprising at least two videos, wherein the selection module is configured to select different simultaneous judging sets for different voting users;
wherein the first presentation portion is for presenting the videos in the simultaneous judging set in a first sequence, and the votes represent preferences for a currently-playing video with respect to a video played immediately before the currently-playing video.

7. The social media-based video contest management system of claim 6, wherein generating a post leaderboard data structure comprises:
calculating scores for the videos in the set of multiple videos that are a function of at least one of:
the votes for a given video, and
the votes for videos other than the given video.

8. The social media-based video contest management system of claim 1, the operations further comprising:
conducting multiple contests with videos including one or more of the multiple videos;
generating a user leaderboard data structure representing a list of the voting users ordered according to votes received from the voting users for the videos in the multiple contests; and
providing, over the network, for display by the multiple client devices of the voting users and/or posting users, the user leaderboard data structure and a third electronic user interface portion comprising a third presentation portion for displaying a rendering of the user leaderboard data structure.

9. A non-transitory machine-readable storage medium encoded with instructions executable by the hardware processor to perform operations for managing the equitable selection and display of videos to be voted on by users, the operations comprising:
receiving, over a network, from multiple client devices of posting users, a set of multiple videos;
storing the received videos in a storage device;
for voting users:
selecting, from the stored videos, via a selection module, one or more subsets of multiple videos from the set of multiple videos, wherein the selection module is configured to manage the overall selection of the subsets of multiple videos such that the overall number of times a given video in the set of multiple is selected is equitable with respect to the number of times other videos in the set of multiple videos are selected; and
providing, over the network, for display by a client device of a given voting user, a first electronic user interface portion comprising a first presentation portion for presenting the videos in one of the subsets selected by the selection module for the given voting user, and a first interactive element operable by the given voting user to generate an input representing a vote for at least one of the videos in the one of the subsets;
receiving, over the network, from the multiple client devices of the voting users, electronic messages representing the votes;
generating a post leaderboard data structure representing a list of the videos ordered according to the received votes; and
providing, over the network, for display by the multiple client devices of the voting users and/or posting users, the post leaderboard data structure and a second electronic user interface portion comprising a second presentation portion for displaying a rendering of the post leaderboard data structure.

10. The non-transitory machine-readable storage medium of claim 9, the operations further comprising:
establishing a submission period during which posting users may submit videos for inclusion in the set of multiple videos and the voting users may submit votes for the videos; and
establishing a judging only period during which no users may submit videos for inclusion in the set of multiple videos and the voting users may submit votes for the videos.

11. The non-transitory machine-readable storage medium of claim 9, the operations further comprising:
calculating raw scores for the videos in the set of multiple videos, wherein the raw score for a given video is calculated based on (i) a number of times the given video is seen by the voting users and (ii) a number of votes cast for the given video.

12. The non-transitory machine-readable storage medium of claim 11, the operations further comprising:
calculating strength of schedule (SOS) scores for the videos in the set of multiple videos based on wins for the videos, wherein a video is accorded a win when the video receives a vote from a voting user over the other videos in the subset, and wherein the SOS score for a given video is calculated based on (i) the raw scores of other videos in the subsets where the given video is accorded a win, (ii) the number of wins the given video is accorded over all other videos in the set of multiple videos, and (iii) a total number of wins accorded the given video.

13. The non-transitory machine-readable storage medium of claim 9, the operations further comprising:
calculating final scores for the videos in the set of multiple videos, wherein the final score for a given video is calculated based on (i) the raw score for the given video and (ii) the SOS score for the given video; and
ordering the list of the videos in the post leaderboard data structure according to the final scores.

14. The non-transitory machine-readable storage medium of claim 9, wherein selecting, from the stored videos, via a selection module, one or more subsets of multiple videos from the set of multiple videos comprises:
selecting, from the stored videos, via the selection module, a simultaneous judging set comprising at least two videos, wherein the selection module is configured to select different simultaneous judging sets for different voting users;
wherein the first presentation portion is for presenting the videos in the simultaneous judging set in a first sequence, and the votes represent preferences for a currently-playing video with respect to a video played immediately before the currently-playing video.

15. The non-transitory machine-readable storage medium of claim 14, wherein generating a post leaderboard data structure comprises:
calculating scores for the videos in the set of multiple videos that are a function of at least one of:
the votes for a given video, and
the votes for videos other than the given video.

16. The non-transitory machine-readable storage medium of claim 9, the operations further comprising:
conducting multiple contests with videos including one or more of the multiple videos;
generating a user leaderboard data structure representing a list of the voting users ordered according to votes received from the voting users for the videos in the multiple contests; and
providing, over the network, for display by the multiple client devices of the voting users and/or posting users, the user leaderboard data structure and a third electronic user interface portion comprising a third presentation portion for displaying a rendering of the user leaderboard data structure.

17. A computer-implemented method for managing the equitable selection and display of videos to be voted on by users, the method comprising:
receiving, over a network, from multiple client devices of posting users, a set of multiple videos;
storing the received videos in a storage device;
for voting users:
selecting, from the stored videos, via a selection module, one or more subsets of multiple videos from the set of multiple videos, wherein the selection module is configured to manage the overall selection of the subsets of multiple videos such that the overall number of times a given video in the set of multiple is selected is equitable with respect to the number of times other videos in the set of multiple videos are selected; and
providing, over the network, for display by a client device of a given voting user, a first electronic user interface portion comprising a first presentation portion for presenting the videos in one of the subsets selected by the selection module for the given voting user, and a first interactive element operable by the given voting user to generate an input representing a vote for at least one of the videos in the one of the subsets;
receiving, over the network, from the multiple client devices of the voting users, electronic messages representing the votes;
generating a post leaderboard data structure representing a list of the videos ordered according to the received votes; and
providing, over the network, for display by the multiple client devices of the voting users and/or posting users, the post leaderboard data structure and a second electronic user interface portion comprising a second presentation portion for displaying a rendering of the post leaderboard data structure.

18. The computer-implemented method of claim 17, further comprising:
establishing a submission period during which posting users may submit videos for inclusion in the set of multiple videos and the voting users may submit votes for the videos; and
establishing a judging only period during which no users may submit videos for inclusion in the set of multiple videos and the voting users may submit votes for the videos.

19. The computer-implemented method of claim 17, further comprising:
calculating raw scores for the videos in the set of multiple videos, wherein the raw score for a given video is calculated based on (i) a number of times the given video is seen by the voting users and (ii) a number of votes cast for the given video.

20. The computer-implemented method of claim 19, further comprising:
calculating strength of schedule (SOS) scores for the videos in the set of multiple videos based on wins for the videos, wherein a video is accorded a win when the video receives a vote from a voting user over the other videos in the subset, and wherein the SOS score for a given video is calculated based on (i) the raw scores of other videos in the subsets where the given video is accorded a win, (ii) the number of wins the given video is accorded over all other videos in the set of multiple videos, and (iii) a total number of wins accorded the given video.

21. The computer-implemented method of claim 17, further comprising:
calculating final scores for the videos in the set of multiple videos, wherein the final score for a given video is calculated based on (i) the raw score for the given video and (ii) the SOS score for the given video; and
ordering the list of the videos in the post leaderboard data structure according to the final scores.

22. The computer-implemented method of claim 17, wherein selecting, from the stored videos, via a selection module, one or more subsets of multiple videos from the set of multiple videos comprises:
selecting, from the stored videos, via the selection module, a simultaneous judging set comprising at least two videos, wherein the selection module is configured to select different simultaneous judging sets for different voting users;
wherein the first presentation portion is for presenting the videos in the simultaneous judging set in a first sequence, and the votes represent preferences for a currently-playing video with respect to a video played immediately before the currently-playing video.

23. The computer-implemented method of claim 17, further comprising:
conducting multiple contests with videos including one or more of the multiple videos;
generating a user leaderboard data structure representing a list of the voting users ordered according to votes received from the voting users for the videos in the multiple contests; and
providing, over the network, for display by the multiple client devices of the voting users and/or posting users, the user leaderboard data structure and a third electronic user interface portion comprising a third presentation portion for displaying a rendering of the user leaderboard data structure.
